(19) United States
(12) Patent Application Publication
(10) Pub. No.: US 2017/0123243 A1
(43) Pub. Date: May 4, 2017

(54) DISPLAY UNIT AND ELECTRONIC APPARATUS

(71) Applicant: SONY CORPORATION, TOKYO (JP)

(72) Inventors: MASAKAZU MITSUGI, KANAGAWA (JP); ATSUHITO YASUI, KANAGAWA (JP)

(21) Appl. No.: 15/128,166

(22) PCT Filed: Mar. 6, 2015
(86) PCT No.: PCT/JP2015/001230

§ 371 Date: Sep. 22, 2016

(30) Foreign Application Priority Data
Mar. 31, 2014 (JP) 2014-074130

(51) Int. Cl. G02F 1/1339; G02F 1/167

(52) U.S. Cl. CPC G02F 1/1339; G02F 1/167; G02F 2202/023; G02F 2001/1678

(57) ABSTRACT

There is provided a display unit including: a first substrate; a second substrate disposed oppositely to the first substrate; a light-transmission or reflection-controllable display layer provided between the first substrate and the second substrate; and a seal layer provided between the first substrate and the display layer, and having a melting temperature of about 120 degrees Celsius or higher and about 250 degrees Celsius or lower.

### CROSS REFERENCE TO RELATED APPLICATIONS

This application is a U.S. National Phase of International Patent Application No. PCT/JP2015/001230 filed on Mar. 6, 2015, which claims priority benefit of Japanese Patent Application No. 2014-074130 filed in the Japan Patent Office on Mar. 31, 2014. Each of the above-referenced applications is hereby incorporated herein by reference in its entirety.

### TECHNICAL FIELD

The present technology relates to a display unit provided with a light-transmission or reflection-controllable display layer and to an electronic apparatus provided with the display unit.

### BACKGROUND ART

In recent years, low-power display units (displays) with high image quality have been in increasing demand, as mobile devices represented by mobile phones and portable information terminals have become widespread. In particular, distribution service of digital books has recently started, and a display having a display quality suitable for reading is desired.

Although displays such as a cholesteric liquid crystal display, an electrophoretic display, an electric-redox-type display, and a twisting ball display have been proposed as such displays, a reflection-type display is advantageous for reading. In the reflection-type display, bright display is performed with use of reflection (scattering) of external light in a manner similar to that of a paper, and thus display quality close to that of the paper is achievable.

Among the reflection-type displays, for example, an electrophoretic display using electrophoresis phenomenon that is low in power consumption and high in response speed is expected to be a major display. The electrophoretic display allows two kinds of charged particles to be dispersed in an insulating liquid, and moves the charged particles in response to an electric field. The two kinds of charged particles are different in reflection characteristics from each other, and its polarities are opposite to each other.

Such an electrophoretic display is formed in such a manner that a substrate provided with a display body and a thin film transistor (TFT) substrate provided with a drive transistor and the like are separately fabricated and then these substrates are bonded to each other. In a case where such a manufacturing method is used, it is necessary to make sheet of the display body. To make a sheet of the display body, it is necessary to provide a seal layer on a back surface side (a bonding surface) of the display body, and the display body and the TFT substrate are bonded to each other with the seal layer in between (for example, see PTL 1).

### CITATION LIST

### Patent Literature

[PTL 1] JP-A-2012-22296

### SUMMARY

### Technical Problem

The seal layer may be formed of, for example, a thermoplastic resin; however, in the electrophoretic display having such a structure, display characteristics are disadvantageously deteriorated drastically in high-temperature storage.

It is desirable to provide a display unit and an electronic apparatus that are capable of suppressing deterioration of the display characteristics in high-temperature storage.

### Solution to Problem

According to an embodiment of the technology, there is provided a display unit including: a first substrate; a second substrate disposed oppositely to the first substrate;

a light-transmission or reflection-controllable display layer provided between the first substrate and the second substrate; and a seal layer provided between the first substrate and the display layer, and having a melting temperature of about 120 degrees Celsius or higher and about 250 degrees Celsius or lower.

According to an embodiment of the technology, there is provided an electronic apparatus provided with a display unit. The display unit includes: a first substrate; a second substrate disposed oppositely to the first substrate; a light-transmission or reflection-controllable display layer provided between the first substrate and the second substrate; and a seal layer provided between the first substrate and the display layer, and having a melting temperature of about 120 degrees Celsius or higher and about 250 degrees Celsius or lower.

In the display unit according to the embodiment of the technology, the seal layer that has the melting temperature of about 120 degrees Celsius or higher and about 250 degrees Celsius or lower is disposed between the display layer and the first substrate. Therefore, it is possible to suppress swelling of the seal layer in high-temperature storage.

### Advantageous Effects of Invention

In the display unit and the electronic apparatus according to the respective embodiments of the technology, the seal layer that has the melting temperature of about 120 degrees Celsius or higher and about 250 degrees Celsius or lower is provided between the display layer and the first substrate, and swelling of the seal layer is accordingly suppressed. Therefore, it is possible to suppress deterioration of the display characteristics in high-temperature storage. Consequently, it is possible to provide an electronic apparatus having high reliability. Incidentally, effects described here are non-limiting. Effects achieved by the technology may be one or more of effects described in the present disclosure.

It is to be understood that both the foregoing general description and the following detailed description are exemplary, and are provided to provide further explanation of the technology as claimed.

### BRIEF DESCRIPTION OF DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a sectional diagram illustrating a structure of a display unit according to an embodiment of the technology.

FIG. 2 is a plan view illustrating a structure of an electrophoretic element illustrated in FIG. 1.

FIG. 3 is a sectional diagram for explaining operation of the display unit illustrated in FIG. 1.

FIG. 4A is a perspective view illustrating an appearance of an application example 1.

FIG. 4B is a perspective view illustrating another example of an electronic book illustrated in FIG. 4A.

FIG. 5 is a perspective view illustrating an appearance of an application example 2.

FIG. 6 is a characteristic diagram illustrating relationship between reflectance and storage time in an experimental example 1 of the technology.

FIG. 7 is a characteristic diagram illustrating relationship between reflectance and storage time in an experimental example 2 of the technology.

### DESCRIPTION OF EMBODIMENTS

Hereinafter, an embodiment of the technology will be described in detail with reference to drawings. Note that description will be given in the following order.

1. Embodiment (electrophoretic display unit)

2. Application examples

3. Examples

### 1 EMBODIMENT

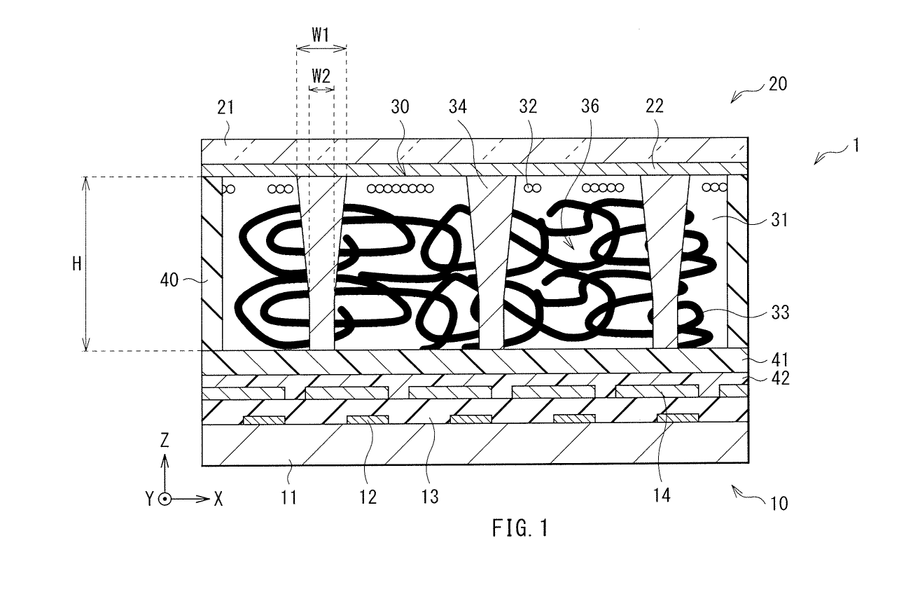

FIG. 1 illustrates a sectional structure of a display unit (a display unit 1) according to an embodiment of the disclosure. The display unit 1 is an electrophoretic display unit that uses an electrophoresis phenomenon to display an image, and has an electrophoretic element 30 as a display body between a drive substrate 10 and an opposing substrate 20. A clearance between the drive substrate 10 and the opposing substrate 20 is formed by spacers 40, and an image is displayed on the opposing substrate 20 side. Incidentally, FIG. 1 schematically illustrates the structure of the display unit 1, and a dimension and a shape of the display unit 1 in FIG. 1 may be different from an actual dimension and an actual shape.

The electrophoretic element 30 includes migrating particles 32 and a porous layer 33 in an insulating liquid 31, is formed on the opposing substrate 20, and is sealed by a seal layer 41. In the present embodiment, the seal layer 41 is formed of a thermoplastic resin that may have a melting temperature (Tm) of about 120 degrees Celsius or higher and about 250 degrees Celsius or lower. The electrophoretic element 30 is stacked on the drive substrate 10 with the seal layer 41 and an adhesive layer (an adhesive layer 42 described later) in between. The electrophoretic element 30 is applicable to various purposes. Here, a case where the electrophoretic element 30 is applied to the display unit 1 is described; however, this is an example of the structure of the display unit 1, and the structure may be appropriately modified. Moreover, the electrophoretic element 30 may be used other than the display unit, and the application thereof is not particularly limited.

The seal layer 41 seals an insulating liquid (the insulating liquid 31 described later) in the electrophoretic element 30 to make the opposing substrate 20 provided with the electrophoretic element 30 into a sheet, and prevents the air from entering the electrophoretic element 30. As described above, the seal layer 41 in the present embodiment is formed with use of, for example, a thermoplastic resin that has the melting temperature of about 120 degrees Celsius or higher and about 250 degrees Celsius or lower as a base material. Examples of the thermoplastic resin may include polyurethane having molecular weight of 1000 or more and 100000 or lower. In addition, for example, an acrylic resin, a polyester resin, and the like may be used. Incidentally, more preferable range of the melting temperature is about 135 degrees Celsius or higher and 200 degrees Celsius or lower. A volume resistivity of the seal layer 41 may be preferably 1.0*10⁸ ohm cm or larger and 1.0*10¹² ohm cm or lower, and more preferably 1.0*10⁹ ohm cm or larger and 1.0*10¹¹ ohm cm or lower. Adjusting the volume resistivity to the above-described range improves response speed of the electrophoretic element 30 and reduces power consumption.

Incidentally, the seal layer 41 may contain an additive. The additive is to improve surface property of the seal layer 41. Specifically, the additive is to suppress adsorption of the migrating particles 32 configuring the electrophoretic element 30, on the surface of the seal layer 41, and for example, may preferably have an acid structure in a molecule. An average molecular weight of the additive may be preferably, for example, 100 or higher and 100000 or lower, and an amount of the additive is about 0.01 wt % or higher and about 10 wt % or lower. Accordingly, it is possible to improve response speed while maintaining memory property that has trade-off relation with the response speed. Specific examples of the additive may include a surfactant and a dispersant.

The drive substrate 10 may include, for example, TFTs 12, a protection layer 13, and pixel electrodes 14 in this order on one surface of a supporting member 11. For example, the TFTs 12 and the pixel electrodes 14 may be arranged in a matrix form or in a segment form depending on pixel arrangement.

For example, the supporting member 11 may be formed of an inorganic material, a metallic material, a plastic material, or the like in the shape of a sheet. Examples of the inorganic material may include silicon (Si), silicon oxide (SiOx), silicon nitride (SiNx), and aluminum oxide (AlOx). Examples of the silicon oxide may include glass and spin on glass (SOG). Examples of the metallic material may include aluminum (Al), nickel (Ni), and stainless steel. Examples of the plastic material may include polycarbonate (PC), polyethylene terephthalate (PET), polyethylene naphthalate (PEN), polyethylether ketone (PEEK), and polyimide (PI).

In the display unit 1, since an image is displayed on a side close to the opposing substrate 20, the supporting member 11 may have no light transmission property. The supporting member 11 may be configured of a substrate having rigidity such as wafer, or may be configured of a thin layer glass, a film, or the like having flexibility. Using a flexible material for the supporting member 11 makes it possible to realize the flexible (foldable) display unit 1.

The TFTs 12 are switching elements to select pixels. The TFTs 12 may be inorganic TFTs using an inorganic semiconductor layer as a channel layer, or organic TFTs using an organic semiconductor layer. The protection layer 13 may be formed of, for example, an insulating resin material such as polyimide, and is to planarize the surface of the supporting member 11 provided with the TFTs 12. The pixel electrodes 14 may be formed of, for example, a conductive material such as gold (Au), silver (Ag), copper (Cu), Al, an Al alloy, and indium tin oxide (ITO). The pixel electrodes 14 may be formed using a plurality of kinds of conductive materials. The pixel electrodes 14 are connected to the TFTs 12 through contact holes (not illustrated) that are provided in the protection layer 13.

For example, the opposing substrate 20 may have a supporting member 21 and opposing electrodes 22, and the opposing electrodes 22 are provided on an entire surface (a surface opposed to the drive substrate 10) of the supporting member 21. The opposing electrodes 22 may be arranged in a matrix form or in a segment form, similarly to the pixel electrodes 14.

A similar material to that of the supporting member 11 may be used for the supporting member 21 as long as the material has light transmission property. A light transmission conductive material (a transparent electrode material) such as ITO, antimony tin oxide (ATO), fluorine-doped tin oxide (FTO), and aluminum-doped zinc oxide (AZO) may be used for the opposing electrodes 22.

In the display unit 1, the electrophoretic element 30 is viewed through the opposing electrodes 22. Therefore, the light transmission property (transmittance) of the opposing electrodes 22 may be preferably as high as possible, and for example, may be about 80% or higher. Moreover, the electric resistance of the opposing electrodes 22 may be preferably as low as possible, and for example, may be about 100 ohm/sq. or lower.

The electrophoretic element 30 generates contrast with use of the electrophoresis phenomenon, and includes the migrating particles 32, the porous layer 33, and partition walls 34 in the insulating liquid 31.

The insulating liquid 31 is filled in a space surrounded by the drive substrate 10 (specifically, the seal layer 41), the opposing substrate 20, and the spacers 40, and may be formed of, for example, an organic solvent such as paraffin and isoparaffin. One kind of organic solvent may be used for the insulating liquid 31 or a plurality of kinds of organic solvents may be mixed and used for the insulating liquid 31. Viscosity and a refractive index of the insulating liquid 31 may be preferably as small as possible. Mobility (response speed) of the migrating particles 32 is improved as the viscosity of the insulating liquid 31 is lowered. In addition, energy (consumed power) necessary for movement of the migrating particles 32 is accordingly decreased. When the refractive index of the insulating liquid 31 is lowered, a difference between the refractive index of the insulating liquid 31 and a refractive index of the porous layer 33 becomes large, and optical reflectance of the porous layer 33 becomes high. The refractive index of the insulating liquid 31 may be, for example, 1.48.

For example, a coloring agent, a charge control agent, a dispersion stabilizer, a viscosity modifier, a surfactant, a resin, or the like may be added to the insulating liquid 31.

The migrating particles 32 are one or two or more charged particles (electrophoretic particles) dispersed in the insulating liquid 31, and such migrating particles 32 are movable through the porous layer 33 in response to an electric field. The migrating particles 32 have arbitrary optical reflection characteristics (optical reflectance), and contrast occurs due to difference between the optical reflectance of the migrating particles 32 and the optical reflectance of the porous layer 33. In the display unit 1, the optical reflectance of the migrating particles 32 is lower than the optical reflectance of the porous layer 33, and dark display is performed by the migrating particles 32 and bright display is performed by the porous layer 33.

Accordingly, when the electrophoretic element 30 is viewed from the outside, the migrating particles 32 may be visually confirmed as, for example, black or a color close to black. The color of the migrating particles 32 is not particularly limited as long as the contrast is allowed to occur.

For example, the migrating particles 32 may be formed of particles (powder) of an organic pigment, an inorganic pigment, a dye, a carbon material, a metallic material, a metal oxide, glass, a polymer material (a resin), and the like. One kind or two or more kinds thereof may be used for the migrating particles 32. The migrating particles 32 may be formed of crushed particles, capsule particles, or the like of a resin solid content containing the above-described particles. Note that materials equivalent to the carbon material, the metallic material, the metal oxide, the glass, and the polymer material are excluded from materials equivalent to the organic pigment, the inorganic pigment, and the dye.

Examples of the above-described organic pigment may include azo pigments, metal complex azo pigments, polycondensation azo pigments, flavanthrone pigments, benzimidazolone pigments, phthalocyanine pigments, quinacridone pigments, anthraquinone pigments, perylene pigments, perinone pigments, anthrapyridine pigments, pyranthrone pigments, dioxazine pigments, thioindigo pigments, isoindolinone pigments, quinophthalone pigments, and indanthrene pigments. Examples of the inorganic pigment may include zinc oxide (e.g. zinc flower), antimony white, black iron oxide, titanium boride, red iron oxide, mapico yellow, minium, cadmium yellow, zinc sulphide, lithopone, barium monosulfide, cadmium selenide, calcium carbonate, barium sulfate, lead chromate, lead sulfate, barium carbonate, white lead, and alumina white. Examples of the dye may include nigrosine dyes, azo dyes, phthalocyanine dyes, quinophthalone dyes, anthraquinone dyes, and methine dyes. Examples of the carbon material may include carbon black. Examples of the metallic material may include gold, silver, and copper. Examples of the metal oxide may include titanium oxide, zinc oxide, zirconium oxide, barium titanate, potassium titanate, copper-chromium oxide, copper-manganese oxide, copper-iron-manganese oxide, copper-chromium-manganese oxide, and copper-iron-chromium oxide. Examples of the polymer material may include a high molecular compound into which a functional group having an optical absorption range in a visible light region is introduced. The kind of the polymer material is not particularly limited as long as such a high molecular compound having the optical absorption range in the visible light region is adopted.

Specifically, for example, a carbon material such as carbon black, or a metal oxide such as copper-chromium oxide, copper-manganese oxide, copper-iron-manganese oxide, copper-chromium-manganese oxide, and copper-iron-chromium oxide, or the like may be used for the migrating particles 32 performing the dark display. Among them, a carbon material may be preferably used for the migrating particles 32. The migrating particles 32 formed of the carbon material exhibit excellent chemical stability, excellent mobility, and excellent light absorption property.

The content (density) of the migrating particles 32 in the insulating liquid 31 may be, for example, about 0.1 wt % to about 10 wt % both inclusive, although it is not particularly limited. A shielding property and mobility of the migrating particles 32 are secured in this density range. Specifically, when the content of the migrating particles 32 is lower than 0.1 wt %, it may be difficult for the migrating particles 32 to shield (hide) the porous layer 33, and contrast may not be sufficiently generated. On the other hand, when the content of the migrating particles 32 is higher than 10 wt %, dispersibility of the migrating particles 32 may decrease. Therefore, the migrating particles 32 are difficult to migrate, which leads to a possibility of occurrence of agglomeration in some cases.

The migrating particles 32 may be preferably readily dispersed and charged in the insulating liquid 31 for a long time, and may be less easily adsorbed on the porous layer 33. Therefore, for example, a dispersant or a charge control agent may be added to the insulating liquid 31. Moreover, the dispersant and the charge control agent may be used together.

For example, the dispersant or the charge control agent may have one or both of positive (+) charge and negative (−) charge, and increases charged amount in the insulating liquid 31 as well as disperses the migrating particles 32 by electrostatic repulsion. Examples of such a dispersant may include Solsperse series made by The Lubrizol Corporation, BYK series made by BYK-Chemic GmbH, OSA series or Anti-Terra series made by Chevron Philips Chemical Company, and Span series made by TCI Americas Inc.

To improve dispersibility of the migrating particles 32, surface treatment may be performed on the migrating particles 32. Examples of the surface treatment may include rosin treatment, surfactant treatment, pigment derivative treatment, coupling agent treatment, graft polymerization treatment, and microencapsulation treatment. Among them, performing the graft polymerization treatment, the microencapsulation treatment, or a combination of these treatments makes it possible to maintain long-term dispersion stability of the migrating particles 32.

For example, a material (an adsorptive material) that contains a functional group capable of being adsorbed on the surface of the migrating particles 32 and a polymeric functional group may be used in such surface treatment. The kind of the functional group capable of being adsorbed is determined depending on the material of the migrating particles 32. For example, when the migrating particles 32 are formed of a carbon material such as carbon black, an aniline derivative such as 4-vinyl aniline may be absorbed. When the migrating particles 32 are formed of a metal oxide, an organosilane derivative such as methacrylate-3-(trimethoxysilyl)propyl may be absorbed. Examples of the polymeric functional group may include a vinyl group, an acrylic group, and a methacryl group.

A polymeric functional group may be introduced on the surface of the migrating particles 32, and a material may be grafted thereon to perform the surface treatment (a graft material). For example, the graft material may contain a polymeric functional group and a functional group for dispersion. The functional group for dispersion is capable of dispersing the migrating particles 32 in the insulating liquid 31 and maintaining dispersibility by steric hindrance. When the insulating liquid 31 may be, for example, paraffin, a branched-alkyl group or the like may be used as the functional group for dispersion. Examples of the polymeric functional group may include a vinyl group, an acryl group, and a methacryl group. To cause polymerization and graft of the graft material, for example, a polymerization initiator such as azobisisobutyronitrile (AIBN) may be used.

Details of a method of dispersing the migrating particles 32 in the insulating liquid 31 as described above are described in books such as “Dispersion technology of ultrafine particles and evaluation thereof: surface treatment and fine grinding, as well as dispersion stability in air/liquid/polymer (Science & Technology Co., Ltd.)”.

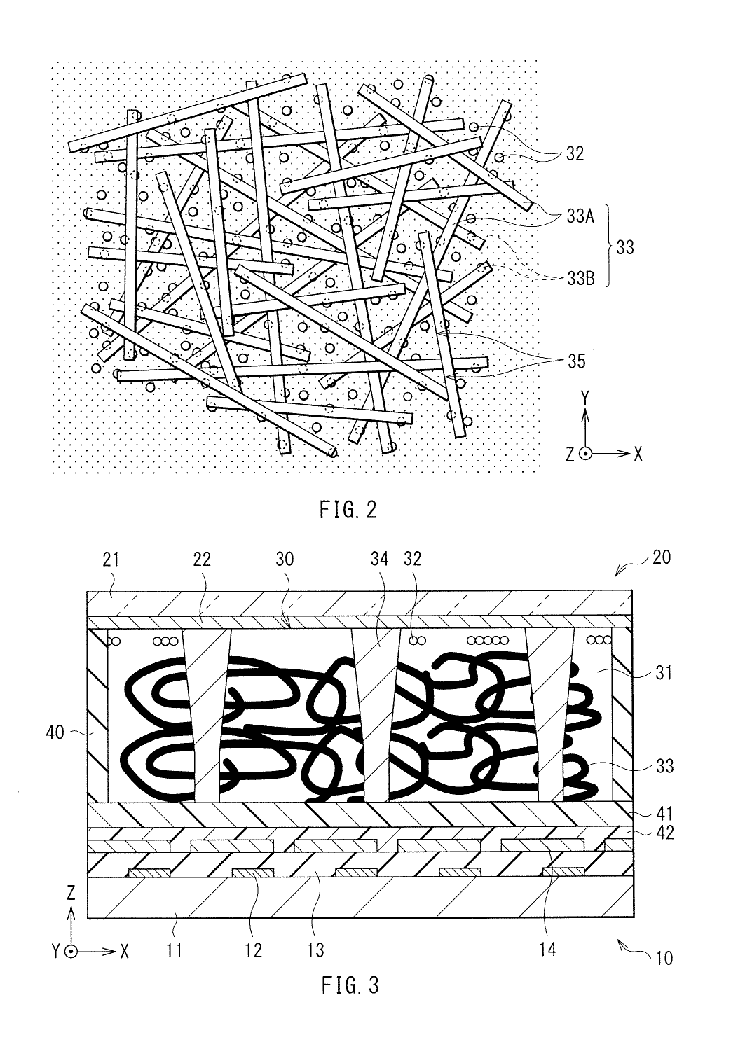

The porous layer 33 is capable of shielding the migrating particles 32. The porous layer 33 has a fibrous structure 33A and non-migrating particles 33B held by the fibrous structure 33A, as illustrated in FIG. 2.

The porous layer 33 is a three-dimensional structure (an irregular network structure such as a non-woven fabric) formed of the fibrous structure 33A, and is provided with a plurality of apertures (pores 35). Forming the three-dimensional structure of the porous layer 33 by the fibrous structure 33A makes it possible to secure sufficient sizes of the pores 35 for movement of the migrating particles 32 and to maintain high contrast even when the porous layer 33 has a small thickness. More specifically, the three-dimensional structure of the porous layer 33 allows light (outside light) to be reflected irregularly (multiply scattered), and increases the optical reflectance of the porous layer 33. Accordingly, even when the porous layer 33 has a small thickness, high optical reflectance is allowed to be obtained. Moreover, using the fibrous structure 33A allows the average pore diameter of the pores 35 to become large, and a lot of pores 35 are allowed to be provided in the porous layer 33. As a result, the migrating particles 32 are easily moved through the pores 35, and the response speed is increased. In addition, the energy necessary for movement of the migrating particles 32 is more decreased. The thickness (in the Z direction) of such a porous layer 33 may be, for example, about 5 micrometers to about 100 micrometers both inclusive.

The fibrous structure 33A is a fibrous substance having a length sufficient with respect to a fiber diameter. For example, a plurality of fibrous structures 33A may be collected and randomly overlapped to form the porous layer 33. One fibrous structure 33A may be randomly tangled to form the porous layer 33. Alternatively, the porous layer 33 formed of one fibrous structure 33A and the porous layer 33 formed of a plurality of fibrous structures 33A may be mixed. FIG. 2 illustrates the porous layer 33 formed of a plurality of fibrous structures 33A.

The fibrous structure 33A may be formed of, for example, a polymer material, an inorganic material, or the like. Examples of the polymer material may include nylon, polyactic acid, polyamide, polyimide, polyethylene terephthalate, polyacrylonitrile, polyethylene oxide, polyvinyl carbazole, polyvinyl chloride, polyurethane, polystyrene, polyvinyl alcohol, polysulfone, polyvinyl pyrrolidone, polyvinylidene fluoride, polyhexafluoropropylene, cellulose acetate, collagen, gelatin, chitosan, and copolymer thereof. Examples of the inorganic material may include titanium oxide. The polymer material may be preferably used for the fibrous structure 33A. This is because the polymer material has low reactivity to light or the like and is chemically stable. In other words, using the polymer material makes it possible to prevent unintentional decomposition reaction of the fibrous structure 33A. When the fibrous structure 33A is formed of a high reactive material, the surface may be preferably coated with an arbitrary protection layer.

For example, the fibrous structure 33A may straightly extend. The fibrous structure 33A may have any shape, and for example, may be frizzled or folded halfway. Alternatively, the fibrous structure 33A may be branched halfway or may undulate. When undulating fibrous structures 33A are entangled, the structure of the porous layer 33 becomes complicated, which makes it possible to improve optical characteristics.

The average fiber diameter of the fibrous structure 33A may be, for example, about 1 nm or larger and about 10000 nm or lower, and in particular, may be preferably about 1 nm or larger and 100 nm or lower. A method in which the porous layer is formed of cellulose, velvet, or the like has been proposed (see JP-A-Sho-50-15120); however, a refractive index of each of these materials is close to that of the insulting liquid, which may cause deterioration in contrast. In addition, a fiber diameter of cellulose and velvet is about 10 micrometers to about 100 micrometers that is large. In contrast, when the average fiber diameter is decreased as described above, light is easily reflected irregularly, and the pore diameter of the pores 35 is increased. The fiber diameter is determined so that the fibrous structure 33A holds the non-migrating particles 33B. For example, the average fiber diameter may be determined through microscope observation using a scanning electron microscope or the like. The average length of the fibrous structure 33A is arbitrary. For example, the fibrous structure 33A may be formed by a phase separation method, a phase inversion method, an electrostatic (electric field) spinning method, a melt spinning method, a wet spinning method, a dry spinning method, a gel spinning method, a sol-gel method, a spray applying method, or the like. Using such methods makes it possible to easily and stably form the fibrous structure 33A that has a sufficient length with respect to the fiber diameter.

The fibrous structure 33A may be preferably formed of nanofibers. Here, the nanofiber has a fiber diameter of about 1 nm to about 100 nm both inclusive and has a length hundred times or more larger than the fiber diameter, which allows light to be easily reflected irregularly and makes it possible to improve the optical reflectance of the porous layer 33. In other words, it is possible to improve the contrast of the electrophoretic element 30. In addition, in the fibrous structure 33A formed of the nanofiber, the percentage of the pores 35 per unit volume is increased, and the migrating particles 32 thus easily move through the pores 35. Therefore, it is possible to decrease the energy necessary for movement of the migrating particles 32. The fibrous structure 33A formed of the nanofibers may be preferably formed by the electrostatic spinning method. Using the electrostatic spinning method makes it possible to easily and stably form the fibrous structure 33A having a small fiber diameter.

The fibrous structure 33A may preferably have an optical reflectance higher than that of the migrating particles 32. As a result, the contrast by the difference between the optical reflectance of the porous layer 33 and the optical reflectance of the migrating particles 32 is easily generated. When the fibrous structure 33A does not substantially affect the optical reflectance of the porous layer 33, that is, when the optical reflectance of the porous layer 33 is determined by the non-migrating particles 33B, the fibrous structure 33A exhibiting optical transparency (clear and colorless) in the insulating liquid 31 may be used.

The pores 35 are formed by the plurality of overlapped fibrous structures 33A or one tangled fibrous structure 33A. The pores 35 may preferably have an average pore diameter as large as possible so as to facilitate movement of the migrating particles 32 through the pores 35. The average pore diameter of the pores 35 may be, for example, about 0.1 micrometer or larger and about 10 micrometers or smaller.

The non-migrating particles 33B are one or two or more particles that are fixed to the fibrous structure 33A and do not perform electrophoresis. The non-migrating particles 33B may be embedded in the inside of the fibrous structure 33A holding the non-migrating particles 33B, or may be partially exposed from the fibrous structure 33A.

The non-migrating particles 33B used have optical reflectance different from that of the migrating particles 32, specifically, has optical reflectance higher than that of the migrating particles 32. The non-migrating particles 33B may be formed of the material similar to the material described for the migrating particles 32. More specifically, a metal oxide such as titanium oxide, zinc oxide, zirconium oxide, barium titanate, and potassium titanate, or the like may be preferably used for the non-migrating particles 33B for performing the bright display. As a result, it is possible to obtain excellent chemical stability, excellent fixity, and excellent optical reflectivity. The material of the non-migrating particles 33B and the material of the migrating particles 32 may be the same as each other or may be different from each other. The non-migrating particles 33 may be visually confirmed as, for example, white or a color close to white from the outside.

The partition walls 34 are columnar partitions each extending in a stacking direction (the Z direction) of the drive substrate 10 and the opposing substrate 20, and are in contact with the drive substrate 10 and the opposing substrate 20. Specifically, a first end of each of the partition walls 34 is in contact with the seal layer 41, and a second end thereof is in contact with the opposing electrodes 22. By providing such partition walls 34, the migrating particles 32 are contained in each cell 36, and movement of the migrating particles 32 between the cells 36 is allowed to be prevented. Therefore, it is possible to suppress occurrence of display unevenness caused by diffusion, convection, agglomeration, or the like of the migrating particles 32, to improve image quality. The partition walls 34 may be preferably aligned in height (in the Z direction). Providing the partition walls 34 having the same height maintains uniform distance (gap) between the seal layer 41 and the opposing electrodes 22 on the entire surface, and it is possible to maintain constant intensity of the electric field. As a result, fluctuation of response speed is eliminated. A clearance H between the drive substrate 10 and the opposing substrate 20 is defined by the height of the partition walls 34. The size of the clearance H may be preferably small. This makes it possible to suppress power consumption. The height of the partition walls 34 may be, for example, about 1 micrometer to about 100 micrometers both inclusive.

Each of the partition walls 34 may have a shape whose width (in the X direction) decreases toward the drive substrate 10 from the opposing substrate 20, namely, a reverse tapered shape. In the partition wall 34, the largest width W1 (a width on a surface opposed to the opposing substrate 20) may be, for example, about 5 micrometers to about 50 micrometers, and the smallest width W2 (a width on a surface opposed to the drive substrate 10) may be, for example, about 1 micrometer to about 30 micrometers.

A planner shape (an XY plane) of the partition wall 34 may be formed in, for example, a lattice shape. Therefore, the cell 36 may have, for example, a quadrilateral shape. Incidentally, the cell 36 may have any shape, for example, a square shape or a rectangular shape. The plurality of cells 36 may be preferably arranged in a matrix form (a plurality of rows*a plurality of columns). A distance (a pitch P of the partition walls 34) between the adjacent partition walls 34 in a predetermined direction (for example, in the X direction) may be, for example, about 50 micrometers to about 500 micrometers both inclusive.

The partition walls 34 may be preferably formed of a light transmission material. The partition walls 34 contain the light transmission material, which makes it possible to suppress light reflection or light absorption caused by the partition walls 34. The partition walls 34 may contain, for example, a photosensitive resin material as the light transmission material. Examples of the photosensitive resin material may include a resin capable of being subjected to optical patterning, for example, a photocurable resin of photo-crosslinking reaction type, photo-modification type, photopolymerization reaction type, and photolysis reaction type. The partition walls 34 may be formed of one kind of photosensitive resin material or may contain a plurality of kinds of photosensitive resin materials. For example, when photo resist that is chemically stable is used as the photosensitive resin material, it is possible to prevent the partition walls 34 from affecting migrating phenomenon of the migrating particles 32. The photo resist may be of negative type or positive type. Any type of a light source may be used to perform patterning of the photosensitive resin, and for example, a semiconductor laser, an excimer laser, an electron beam, an ultraviolet ray, a metal halide lamp, a high-pressure mercury vapor lamp, or the like may be used.

The spacers 40 are to seal the electrophoretic element 30 between the drive substrate 10 and the opposing substrate 20, and may be formed of, for example, an insulating material such as a polymer material. Providing the spacers 40 makes it possible to prevent the air from entering the electrophoretic element 30 from the outside. For example, a seal member containing fine particles may be used for such spacers 40. The spacers 40 may be preferably so disposed as not to prevent movement of the migrating particles 32. A thickness of each of the spacers 40 is substantially the same as the height of each of the partition walls 34, namely, the size of the clearance H. The spacers 40 may run off the edge of the opposing substrate 20 or the drive substrate 10.

The above-described seal layer 41 and adhesive layer 42 are provided between the drive substrate 10 and the electrophoretic element 30. The adhesive layer 42 is to bond the drive substrate 10 to the electrophoretic element 30 (specifically, the seal layer 41), and may be formed of, for example, an acrylic resin or a urethane resin. A rubber adhesive sheet or the like may be used for the adhesive layer 42.

Such a display unit 1 may be manufactured by the following procedure, for example.

First, after the opposing electrodes 22 are provided on a surface of the supporting member 21 to form the opposing substrate 20, the partition walls 34 are formed on the opposing electrodes 22. The opposing electrodes 22 may be formed using existing methods such as various film formation methods. The partition walls 34 may be formed by, for example, an imprint method. First, a solution containing the material (for example, a photosensitive resin material) of the partition walls 34 is applied on the opposing electrodes 22. Then, a mold having a concave section is pressed thereto and is exposed, and then the mold is removed. As a result, columnar partition walls 34 are formed. In the case of the partition walls 34 each having a reverse tapered shape, the mold is easily removed from the partition walls 34.

After the partition walls 34 are provided, the porous layer 33 is formed between the adjacent partition walls 34, in other words, in each cell 36. Specifically, first, the porous layer 33 is formed on the opposing electrodes 22. For example, after titanium oxide as the non-migrating particles 33B is added to a spinning solution and the resultant solution is sufficiently stirred, and then the porous layer 33 is formed by spinning this solution. The spinning solution may be prepared by dispersing or dissolving polyacrylonitrile as the fibrous structure 33A to N,N′-dimethylfolmamide. For example, an electrostatic spinning method may be used for the spinning. In place of the electrostatic spinning method, a phase separation method, a phase inversion method, a melt spinning method, a wet spinning method, a dry spinning method, a gel spinning method, a sol-gel method, a spray applying method, or the like may be used.

The spinning method may be preferably used for formation of the fibrous structure 33A. Although a method in which pores are formed on a polymer film by laser processing to form a porous layer has been also proposed (see JP-A-2005-107146), only large pores each having a pore diameter of about 50 micrometers are formed by the method, and therefore, there is a possibility that the migrating particles are not sufficiently shielded by the porous layer.

After the porous layer 33 is formed, the porous layer 33 is divided and contained in each cell 36. When the porous layer 33 formed by the spinning is pressed from above (in a direction opposite to the supporting member 21), the porous layer 33 is chafed and divided by the partition walls 34. The divided porous layer 33 is contained in a space between the partition walls 34. In this way, the porous layer 33 in which the non-migrating particles 33B are held by the fibrous structure 33A is allowed to be formed for each cell 36.

Subsequently, the seal layer 41 is formed on a peeling member. The seal layer 41 is formed in such a manner that, for example, thermoplastic polyurethane, methyl ethyl ketone (MEK), and cyclohexanone are mixed at a predetermined ratio and are sufficiently dissolved, and then an additive is added thereto. The resultant is applied on the peeling member, and then is heated and dried to form the seal layer 41. Then, after the insulating liquid 31 in which the migrating particles 32 are dispersed is applied on the porous layer 33 on the opposing substrate 20, the opposing substrate 20 and the peeling member having the seal layer 41 are disposed oppositely to each other and bonded by pressing. After that, the seal layer 41 is peeled off from the peeling member, and is fixed to the drive substrate 10 by the adhesive layer 42. For example, the TFTs 12, the protection layer 13, and the pixel electrodes 14 are previously formed in this order on a surface of the supporting member 11 of the drive substrate 10 by using, for example, an existing method. By the above processes, the display unit 1 is completed. The display unit 1 may be manufactured by using a roll to roll method.

In the display unit 1, all of the migrating particles 32 dispersed in the insulating liquid 31 are arranged on a side close to the pixel electrodes 14 in an initial state (FIG. 1). At this time, when the electrophoretic element 30 is viewed from the opposing substrate 20 side, the migrating particles 32 are shielded by the porous layer 33, and therefore, an image is not displayed.

When the pixels are selected by the TFTs 12 and an electric field is applied between the pixel electrodes 14 and the opposing electrodes 22, the migrating particles 32 pass through the pores 35 of the porous layer 33 and move toward the opposing electrodes 22, in the selected pixels as illustrated in FIG. 3. At this time, when the electrophoretic element 30 is viewed from the opposing substrate 20 side, the electrophoretic element 30 is in a state where both of the dark-display pixels in which the porous layer 33 is shielded by the migrating particles 32 and the bright-display pixels in which the porous layer 33 is not shielded by the migrating particles 32 exist. Contrast is generated by the dark-display pixels and the bright-display pixels, and an image is displayed on the opposing substrate 20 side.

As described above, the typical display unit using the electrophoretic element as the display body (the electrophoretic display) is fabricated by bonding the display body that is previously made into a sheet to the TFT substrate. The display body is made into a sheet by providing a seal layer on a surface of the display body bonded to the TFT substrate. However, the display unit having such a structure is disadvantageously deteriorated in display characteristics drastically in high-temperature storage. Typically, the lifetime estimation and reliability of an electronic apparatus may be examined by, for example, acceleration test in high-temperature storage. Therefore, deterioration of the characteristics in the high-temperature storage means low reliability of the electronic apparatus.

Although the detail is not apparent, it is inferred that, for example, the seal layer is swollen under the high temperature condition and thus the additives such as a dispersant contained in the insulating liquid are adsorbed on the seal layer. The additives contained in the insulating liquid are adsorbed on the seal layer, which causes degradation of the dispersibility of the migrating particles. This lowers the reflectance, namely, the display characteristics are degraded.

In contrast, in the present embodiment, forming the seal layer 41 that seals the electrophoretic element 30 configuring the display unit 1 with use of a material having a melting temperature of about 120 degrees Celsius or higher and about 250 degrees Celsius or lower makes it possible to suppress swelling of the seal layer 41 in the high-temperature storage.

As described above, in the display unit 1 according to the present embodiment, the seal layer 41 that is in contact with the electrophoretic element 30 is formed with use of a material having a melting temperature of about 120 degrees Celsius or higher and about 250 degrees Celsius or lower. Therefore, swelling of the seal layer 41 in the high-temperature storage is suppressed. Accordingly, adsorption of the additives such as a dispersant contained in the insulating liquid 31 by the seal layer 41 in the high-temperature storage is suppressed, and degradation of dispersibility of the migrating particles is allowed to be suppressed. As a result, degradation of the display characteristics is suppressed.

### 2. APPLICATION EXAMPLES

Next, application examples of the above-described display unit 1 will be described. The display unit 1 may be mounted on, for example, the following electronic apparatuses. However, configurations of the electronic apparatuses described below are merely examples, and thus the configurations are appropriately modified.

### Application Example 1

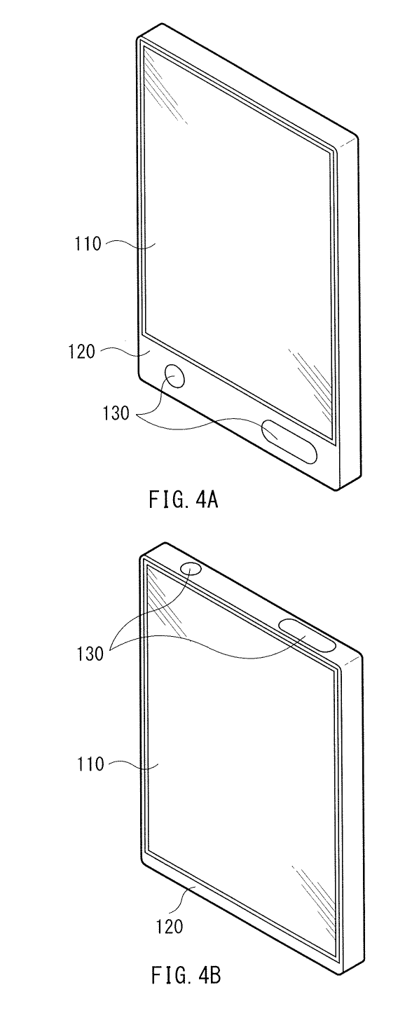

FIGS. 4A and 4B each illustrate an appearance configuration of an electronic book. For example, the electronic book may include a display section 110, a non-display section 120, and an operation section 130. Note that the operation section 130 may be provided on a front surface of the non-display section 120 as illustrated in FIG. 4A or may be provided on a top surface as illustrated in FIG. 4B. The display section 110 is configured of the display unit 1. Note that, the display unit 1 may be mounted on a personal digital assistants (PDA) having a configuration similar to that of the electronic book illustrated in FIGS. 4A and 4B.

### Application Example 2

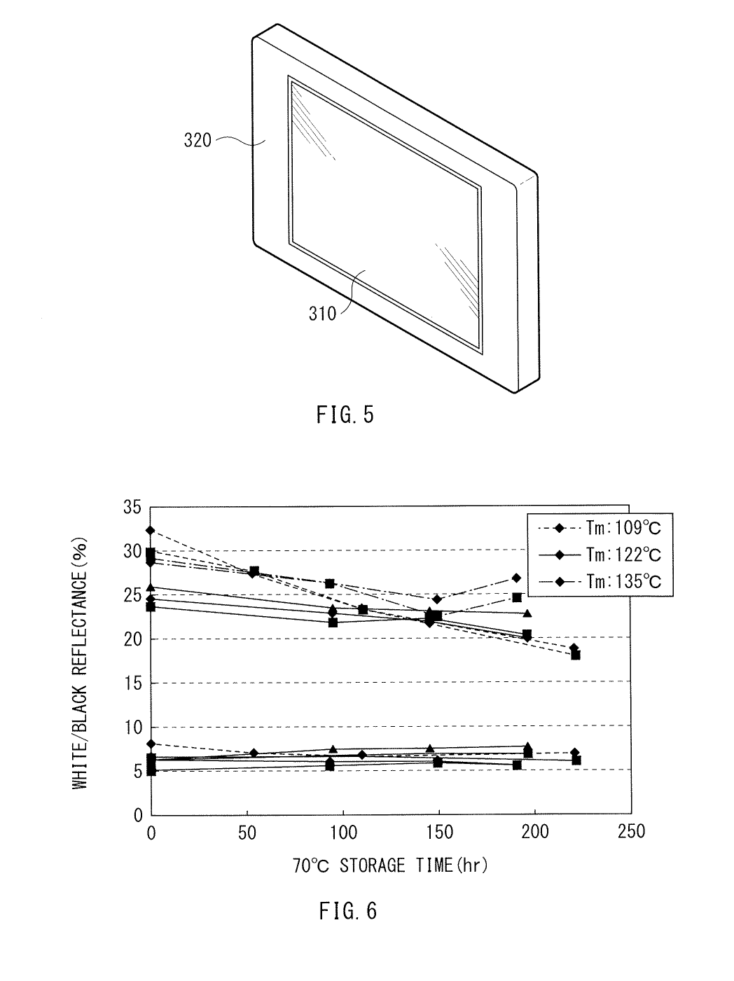

FIG. 5 illustrates an appearance of a tablet personal computer. For example, the tablet personal computer may include a touch panel section 310 and a housing 320, and the touch panel section 310 is configured of the above-described display unit 1.

### 3. EXAMPLES

Next, examples of the present technology will be described.

### Experimental Example 1

The display unit 1 (experimental examples 1-1 to 1-3) was fabricated in the following procedure, and initial reflectance thereof and reflectance after thermal acceleration test were measured.

(Preparation of Migrating Particles)

First, 10 g of carbon black (#40 made by Mitsubishi Chemical Corporation) was added to 1 l of water, followed by stirring, and then 1 ml of hydrochloric acid (37 wt %) and 0.2 g of 4-vinylaniline were added thereto to prepare a solution A. Subsequently, after 0.3 g of sodium nitrite was dissolved to 10 ml of water, the resultant was heated to 40 degrees Celsius to prepare a solution B. Then, the solution B was slowly added to the solution A and reacted while being stirred for 10 hours, followed by centrifugal separation to obtain a solid of a product material. The product material was washed with water, and then washed with added acetone while being subjected to centrifugal separation, followed by drying by a vacuum dryer (at 50 degrees Celsius).

Subsequently, 5 g of the product material, 100 ml of toluene, 15 ml of 2-ethylhexyl methacrylate, and 0.2 g of AIBN were added to a reaction flask provided with a nitrogen purge apparatus, an electromagnetic stirring rod, and a reflux column, and the reaction flask was purged with nitrogen for 30 minutes while stirring. Then, the reaction flask was stirred in a hot bath at 80 degrees Celsius for 10 hours. Subsequently, the product material was centrifuged, tetrahydrofuran (THF) and ethyl acetate were further added thereto, and centrifugal separation was performed three times followed by washing, and then the resultant was dried by a vacuum dryer (at 50 degrees Celsius). As a result, 4.7 g of polymer-coated carbon black that was black migrating particles 32 was obtained.

(Preparation of Insulating Liquid)

Next, 10 wt % of N,N-dimethylpropan-1,3-diamine, 12-hydroxy octadecanoic acide, and methoxysulfonyl oxymethane (Solsperse17000 made by Lubrizol Corporation), 5.0% of sorbitan tri-orate (Span85), and 94% of isoparaffin (IsoparG made by Exxon Mobile Corporation) as a first component were mixed to prepare the insulating liquid. Here, as necessary, 0.1 g of the migrating particles was added to 9.9 g of the insulating liquid, the resultant was stirred with a bead mill for five minutes and then beads were removed to prepare the insulating liquid in which the migrating particles 32 were dispersed. Incidentally, the insulating liquid may be prepared by adding succinimide (OAS 1200 made by Chevron Philips Chemical Company) besides the above-described materials.

(Preparation of Porous Layer)

Subsequently, 12 g of polyacrylonitrile (made by Sigma-Aldrich Co., LLC, molecular weight=150000) as a formation material of the fibrous structure was dissolved to 88 g of N,N′-dimethylformamide to prepare a spinning solution (a solution C). Then, for example, 30 g of titanium oxide (TITONE R-42 made by Sakai Chemical Industry Co., Ltd.) as the non-migrating particles 32 was added to 70 g of the solution C and mixed with a bead mill to prepare a spinning solution (a solution D). Subsequently, spinning for eight reciprocation was performed (the fibrous structure 33A) on the PET substrate that has the partition walls and the pixel electrodes (ITO) formed in a predetermined pattern, with use of an electric field spinning apparatus (NANON manufactured by MECC Co., Ltd.). Here, as the spinning condition, the intensity of the electric field was 28 kV, the discharge speed was 0.5 cm³/min, the spinning length was 15 cm, and the scan rate was 20 mm/sec. Next, the PET substrate was put into a vacuum oven to dry the fibrous structure 33A containing the non-migrating particles 33B at 75 degrees Celsius for 12 hours, and as a result, the porous layer 33 was formed. After that, the porous layer 33 was contained in the partition walls 34 by pressing to form the porous layer 33 in which the non-migrating particles 33B were held by the fibrous structure 33A, for each cell 36.

(Assembly of Display Unit)

Subsequently, after the partition wall 34 was formed with use of the above-described method, the seal layer 41 was formed on a peeling substrate. First, after MEK and cyclohexanone were mixed with respect to 1 g of pellets of thermoplastic polyurethane (E780PSTJ made by Nippon Mirachtran Co., Ltd.) such that the ratio of thermoplastic polyurethane, MEK, and cyclohexanone became 1:4:2, 0.03 g (3 wt % with respect to polyurethane base material) of a nonionic additive (MALIALIM AKM-0531 made by NOF CORPORATION) was added thereto, and the resultant was stirred by a roll mill for eight hours to completely dissolve the nonionic additive to prepare a solution E. The solution E was applied on a PET separator by using an applicator having a slit width of 120 micrometers, and then the resultant was dried on a hot plate at 90 degrees Celsius for five minutes to obtain the seal layer 41 in a sheet form (a thickness of 10 micrometers).

Subsequently, after the insulating liquid 31 was applied on the porous layer 33 on the PET substrate, the front surface of the PET substrate disposed with the porous layer 33 and the seal layer 41 were disposed oppositely to each other, and were hot-pressed with use of a laminator that is heated to 110 degrees Celsius. Incidentally, here, sealing of the PET substrate by the seal layer 41 was performed by hot pressing with use of a laminator. However, the method was not limited thereto, and alternatively, for example, a method in which curing is performed by UV irradiation or the like may be used. Subsequently, the peeling substrate was peeled off from the seal layer 41, and then the drive substrate 10 provided with the TFTs 12 and the like was bonded to the seal layer 41 with the adhesive layer 42 in between to fabricate the display unit 1 (the experimental example 1-1).

In addition, the experimental examples 1-2 to 1-4 were fabricated with changing the material configuring the seal layer 41, and variation of the reflectance before and after high-temperature storage was measured. Here, the high-temperature storage was a so-called thermal acceleration test in which a test object was kept in a constant temperature bath heated to 70 degrees Celsius for about 200 hours. Table 1 shows the material of the seal layer, the melting temperature (degrees Celsius), the initial reflectance (%), the reflectance (%) after the thermal acceleration test, and the volatility (%) in the respective experimental examples. FIG. 6 illustrates relationship between white reflectance, black reflectance, and storage time in a constant temperature bath in the experimental examples 1-1 to 1-4.

TABLE 1

| | | Melting | | Reflectance | |
|---|---|---|---|---|---|
| | | Tem- | Initial | after | |
| | | perature | Reflec- | Thermal | Volatility |
| | | (degrees | tance | Acceleration | (%, |
| | Seal Layer | Celsius) | (%) | Test (%) | average) |
| Experi- | E780PSTJ | 109 | 32.07 | 18.72 | −40.6 |
| mental | | | 29.56 | 17.87 | |
| Example | | | | | |
| 1-1 | | | | | |
| Experi- | E780M128 | 122 | 25.86 | 22.64 | −14.9 |
| mental | | | 24.39 | 19.89 | |
| Example | | | 23.48 | 20.24 | |
| 1-2 | | | | | |
| Experi- | P22MRNAT | 135 | 28.92 | 24.45 | −11.1 |
| mental | | | 28.50 | 26.59 | |
| Example | | | | | |
| 1-3 | | | | | |

| | | | |
|---|---|---|---|
| Experi- | E564PNAT | 206 | Unformable |
| mental | | | |
| Example | | | |
| 1-4 | | | |

As can be seen from Table 1 and FIG. 6, variation of the reflectance after the thermal acceleration test was suppressed by using a material having a high melting temperature for the seal layer 41. Specifically, forming the seal layer 41 by using polyurethane having a melting temperature of 122 degrees Celsius or higher makes it possible to drastically suppress variation of the reflectance before and after the thermal acceleration test. Moreover, as in the experimental example 1-4, in the case of the material whose melting temperature exceeded 200 degrees Celsius, polyurethane did not flow in the hot pressing of the display unit, and thus the seal layer 41 formed of such a material was not allowed to be bonded to the partition walls. Therefore, it is not possible to form the display body.

### Experimental Example 2

The migrating particles and the porous layer were fabricated in the following way. First, after 42.624 g of sodium hydroxide and 0.369 g of sodium silicate were dissolved in 43 g of water, 5 g of complex oxide fine particles (oxide of copper, iron, and manganese, DAIPYROXIDE Color TM3550 made by Dainichiseika Color & Chemicals Mfg. Co., Ltd.) was added to the solution while the solution was stirred. After the solution was stirred for 15 minutes, supersonic wave stirring (at 30 degrees Celsius to 35 degrees Celsius, for 15 minutes) was performed. Then, the complex oxide fine particles-dispersed liquid was heated at 90 degrees Celsius, followed by dropping, for two hours, of 15 cm³ (mL) of 0.22 mol/cm³ sulfuric acid and 7.5 cm³ of water solution in which 6.5 mg of sodium silicate and 1.3 mg of sodium hydroxide were dissolved. Subsequently, the solution was cooled to room temperature, and then 1.8 cm³ of 1 mol/cm³ sulfuric acid was added, which was followed by centrifugal separation (at 3700 rpm, for 30 minutes) and decantation. Next, precipitate obtained by the decantation was redispersed in ethanol, which was followed by centrifugal separation (at 3500 rpm, for 30 minutes) and decantation. Precipitate obtained by repeating this washing operation twice was put into a bottle, a mixed solution of 5 cm³ of ethanol and 0.5 cm³ of water was added to the bottle, and then supersonic wave stirring was performed (for one hour). As a result, a dispersion solution of silane-coated complex oxide particles was obtained.

Next, 3 cm³ of water, 30 cm³ of ethanol, and 4 g of N-[3-(trimethoxysilyl)propyl]-N′-(4-vinylbenzyl)ethylenediamine hydrochloride (a 40% methanol solution) were mixed and stirred for seven minutes, and then the whole quantity of the above-described dispersion solution of silane-coated complex oxide particles was added thereto. Subsequently, this mixed solution was stirred for ten minutes, and then subjected to centrifugal separation (at 3500 rpm, for 30 minutes) and decantation. After that, precipitate obtained by the decantation was redispersed in ethanol, which was followed by centrifugal separation (at 3500 rpm, for 30 minutes) and decantation. Precipitate obtained by repeating this washing operation twice was dried for 6 hours in a decompression environment at room temperature, and then dried for 2 hours in a decompression environment at 70 degrees Celsius, so that a solid was obtained.

Next, 50 cm³ of toluene was added to the solid, and then stirred for 12 hours with a roll mill. The resultant was then moved into a three neck flask, 1.7 g of 2-ethyl hexyl acrylate was added thereto, and then was stirred for 20 minutes in a nitrogen gas stream. Next, after the mixed solution was further stirred at 50 degrees Celsius for 20 minutes, 3 cm³ of toluene solution in which 0.01 g of AIBN was dissolved was added thereto, and the mixed solution was then heated at 65 degrees Celsius. Subsequently, after the mixed solution was stirred for 1 hour and then cooled to room temperature, this mixed solution was poured into a bottle together with ethyl acetate. After the bottle was subjected to centrifugal separation (at 3500 rpm, for 30 minutes) and decantation, precipitate obtained by the decantation was redispersed in ethyl acetate, which was followed by centrifugal separation (at 3500 rpm, for 30 minutes) and decantation. After this washing operation by ethyl acetate was repeated three times, obtained precipitate was dried for 12 hours in a decompression environment at room temperature, and was further dried for 2 hours in a decompression environment at 70 degrees Celsius. By the above-described steps, black migrating particles formed of a polymer coated pigment were obtained.

After the migrating particles were prepared, an insulating liquid containing 0.5% of methoxysulfonyloxymethane (Solsperse17000 made by The Lubrizol Corporation) and 1.5% of Sorbitan Laurate (Span20) as a dispersant and a charge control agent was prepared. As an insulating liquid, isoparaffin (IsoparG made by Exxon Mobil Corporation) was used. Then, 0.1 g of the above-described migrating particles were added to 9.9 g of this solution, and the resultant solution was stirred for 5 hours with a bead mill, then zirconia beads (0.03 mm in diameter) were added, followed by stirring for 4 hours with a homogenizer. After that, the zirconia beads were removed and an average particle diameter of the migrating particles was measured, and thus the average diameter of 100 nm was obtained. Zeta electrometer particle diameter measurement system ELSZ-2 (manufactured by Otsuka Electronic Co., Ltd.) was used for the measurement of the average particle diameter.

On the other hand, the porous layer was formed in the following manner. First, as a material of fibrous structure, polymethyl methacrylate was prepared. After 14 g of polymethyl methacrylate was dissolved in 86 g of N,N′-dimethylformamide, 30 g of titanium oxide as non-migrating particles having a primary particle diameter of 250 nm was added to 70 g of the solution, and the resultant was mixed with a bead mill. As a result, a spinning solution for forming the fibrous structure was obtained. After the partition walls were formed on a drive substrate that was provided with pixel electrodes formed of ITO in a predetermined pattern, spinning was performed with use of the spinning solution. Specifically, the spinning solution was put into a syringe, and spinning for 1.2 mg/cm² was performed on the drive substrate. By the above-described steps, a porous layer (fibrous structure holding non-migrating particles) was formed on the drive substrate. The spinning was performed with use of an electric field spinning apparatus (NANON manufactured by MECC Co., Ltd.). A surface potential of formed fibrous structure was measured with use of zeta potential measurement apparatus for surface analysis (SurPASS manufactured by Anton Paar GmbH), and as a result, the surface potential was −7 mV. Measurement was performed using a value at pH7 as the surface potential. After that, the porous layer 33 was contained in the partition walls 34 by pressing to form the porous layer 33 in which the non-migrating particles 33B were held by the fibrous structure 33A for each cell 36.

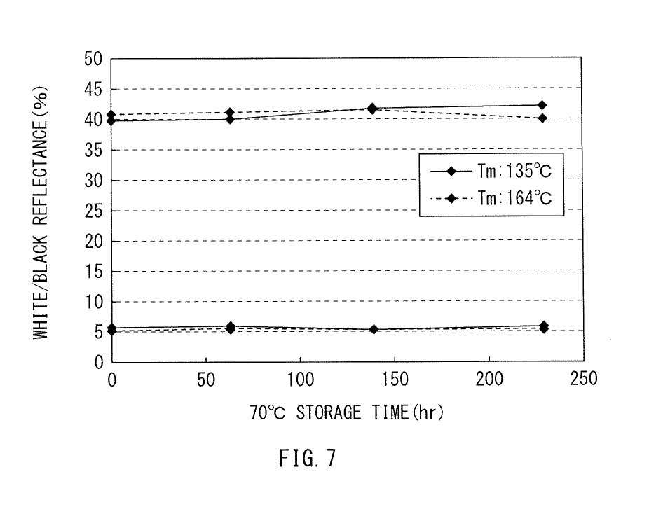

In addition, the display unit 1 was fabricated with use of P22MRNAT (the experimental example 2-1) or E660MZAA (the experimental example 2-2) as the material of the seal layer 41, and variation of the reflectance before and after the high-temperature storage was measured. Incidentally, in the thermal acceleration test here, a test object was kept in a constant temperature bath heated at 70 degrees Celsius for about 230 hours. Table 2 shows the material of the seal layer, the melting temperature (degrees Celsius), the initial reflectance (%), the reflectance after the thermal acceleration test (%), and the volatility (%) in the respective experimental examples. FIG. 7 illustrates relationship between white reflectance, black reflectance, and storage time in a constant temperature bath in the experimental examples 2-1 and 2-2.

TABLE 2

[symbol]

[symbol]

indicates data missing or illegible when filed

As can be seen from Table 2 and FIG. 7, variation of the reflectance after the thermal acceleration test was suppressed by using a material having a high melting temperature (here, 135 degrees Celsius and 164 degrees Celsius) for the seal layer 41. Incidentally, in the experimental example 2-1, the volatility was lowered to about 5%. Therefore, it was found that the absolute value of the volatility is affected by a material configuring the display unit.

Hereinbefore, although the technology has been described with referring to the embodiment and the examples, the technology is not limited to the above-described embodiment and the like, and various modifications may be made. For example, in the above-described embodiment and the like, the case where the dark display is performed by the migrating particles and the bright display is performed by the porous layer has been described. However, the dark display may be performed by the porous layer and the bright display may be performed by the migrating particles.

In addition, in the above-described embodiment and the like, the case where the drive substrate 10 and the seal layer 41 are fixed with the adhesive layer 42 in between has been described; however, the seal layer 41 may be directly fixed to the drive substrate 10.

Furthermore, in the above-described embodiment and the like, a method in which the insulating liquid 31 is applied to the opposing substrate 20 provided with the porous layer 33 and then the opposing substrate 20 is disposed oppositely to the seal layer 41 has been described. However, the display unit 1 may be manufactured by other methods. For example, the insulating liquid 31 may be filled after the drive substrate 10 and the seal layer 41 are oppositely disposed.

Moreover, in the above-described embodiment and the like, the electrophoretic element is used as the display body. However, this is not limitative, and for example, the present technology may be applied to a display unit using a liquid optical element. The liquid optical element may be, for example, a so-called electrowetting element having a non-polar liquid and a polar liquid.

Note that the effects described in the present specification are illustrative and non-limiting. Effects achieved by the technology may be effects other than those described above.

Note that the technology may be configured as follows.

(1)

A display unit including:

a first substrate;

a second substrate disposed oppositely to the first substrate;

a light-transmission or reflection-controllable display layer provided between the first substrate and the second substrate; and

a seal layer provided between the first substrate and the display layer, and having a melting temperature of about 120 degrees Celsius or higher and about 250 degrees Celsius or lower.

(2)

The display unit according to (1), wherein the melting temperature of the seal layer is about 135 degrees Celsius or higher and about 200 degrees Celsius or lower.

(3)

The display unit according to (1) or (2), wherein the seal layer has a volume resistivity of about 1.0*10⁸ ohm cm or larger and about 1.0*10¹² ohm cm or lower.

(4)

The display unit according to (1) or (2), wherein the seal layer has a volume resistivity of about 1.0*10⁹ ohm cm or larger and about 1.0*10¹¹ ohm cm or lower.

(5)

The display unit according to any one of (1) to (4), wherein the seal layer is made of polyurethane.

(6)

The display unit according to (5), wherein the polyurethane has a molecular weight of about 1000 or larger and about 100000 or lower.

(7)

The display unit according to any one of (1) to (6), wherein

the display layer includes migrating particles and a porous layer made of a fibrous structure, in an insulating liquid, and

the fibrous structure has light reflectivity different from light reflectivity of the migrating particles, and includes non-migrating particles that are at least partially modified by a surfactant.

(8)

The display unit according to (7), wherein the fibrous structure is formed by an electrostatic spinning method.

(9)

The display unit according to (7) or (8), wherein

the non-migrating particles has an optical reflectance higher than an optical reflectance of the migrating particles,

the migrating particles perform dark display, and

the non-migrating particles and the fibrous structure perform bright display.

(10)

The display unit according to any one of (7) to (9), wherein the migrating particles and the non-migrating particles are each formed of one or more of an organic pigment, an inorganic pigment, a dye, a carbon material, a metallic material, a metal oxide, glass, and a polymer material.

(11)

The display unit according to any one of (7) to (10), wherein a dispersant dispersing the migrating particles is contained in the insulating liquid.

(12)

An electronic apparatus provided with a display unit, the display unit including:

a first substrate;

a second substrate disposed oppositely to the first substrate;

a light-transmission or reflection-controllable display layer provided between the first substrate and the second substrate; and

a seal layer provided between the first substrate and the display layer, and having a melting temperature of about 120 degrees Celsius or higher and about 250 degrees Celsius or lower.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Display unit

10 Drive substrate

11 Supporting member

12 TFT

13 Protection layer

14 Pixel electrode

20 Opposing substrate

21 Supporting member

22 Opposing electrode

30 Electrophoretic element

31 Insulating liquid

32 Migrating particle

33 Porous layer

33A Fibrous structure

33B Non-migrating particle

34 Partition wall

35 Pore

36 Cell

40 Spacer

41 Seal layer

42 Adhesive layer

1. A display unit comprising:
a first substrate;
a second substrate disposed oppositely to the first substrate;
a light-transmission or reflection-controllable display layer provided between the first substrate and the second substrate; and
a seal layer provided between the first substrate and the display layer, and having a melting temperature of about 120 degrees Celsius or higher and about 250 degrees Celsius or lower.

2. The display unit according to claim 1, wherein the melting temperature of the seal layer is about 135 degrees Celsius or higher and about 200 degrees Celsius or lower.

3. The display unit according to claim 1, wherein the seal layer has a volume resistivity of about 1.0*10⁸ ohm cm or larger and about 1.0*10¹² ohm cm or lower.

4. The display unit according to claim 1, wherein the seal layer has a volume resistivity of about 1.0*10⁹ ohm cm or larger and about 1.0*10¹¹ ohm cm or lower.

5. The display unit according to claim 1, wherein the seal layer is made of polyurethane.

6. The display unit according to claim 5, wherein the polyurethane has a molecular weight of about 1000 or larger and about 100000 or lower.

7. The display unit according to claim 1, wherein
the display layer includes migrating particles and a porous layer made of a fibrous structure, in an insulating liquid, and
the fibrous structure has light reflectivity different from light reflectivity of the migrating particles, and includes non-migrating particles that are at least partially modified by a surfactant.

8. The display unit according to claim 7, wherein the fibrous structure is formed by an electrostatic spinning method.

9. The display unit according to claim 7, wherein
the non-migrating particles has an optical reflectance higher than an optical reflectance of the migrating particles,
the migrating particles perform dark display, and
the non-migrating particles and the fibrous structure perform bright display.

10. The display unit according to claim 7, wherein the migrating particles and the non-migrating particles are each formed of one or more of an organic pigment, an inorganic pigment, a dye, a carbon material, a metallic material, a metal oxide, glass, and a polymer material.

11. The display unit according to claim 7, wherein a dispersant dispersing the migrating particles is contained in the insulating liquid.

12. An electronic apparatus provided with a display unit, the display unit comprising:
a first substrate;
a second substrate disposed oppositely to the first substrate;
a light-transmission or reflection-controllable display layer provided between the first substrate and the second substrate; and
a seal layer provided between the first substrate and the display layer, and having a melting temperature of about 120 degrees Celsius or higher and about 250 degrees Celsius or lower.
